(19) United States
(12) Patent Application Publication
(10) Pub. No.: US 2008/0141161 A1
(43) Pub. Date: Jun. 12, 2008

(54) DYNAMIC TAB CONTROL RESIZING IN A USER INTERFACE

(76) Inventors: Mary E. Raven, Merrimack, NH (US); Jeffrey N. Eisen, Newton, MA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(21) Appl. No.: 11/609,187

(22) Filed: Dec. 11, 2006

(51) Int. Cl. G06F 3/048

(52) U.S. Cl. 715/777

(57) ABSTRACT

Embodiments of the present invention address deficiencies of the art in respect to tab width truncation in a tab control and provide a method, system and computer program product for differentiated truncation of tabs in a tab control. In one embodiment, a differentiated tab truncation method can be provided. The method can include determining a priority for each tab in a tab control, adjusting at least one dimension for each tab in the tab control according to the determined priority, and rendering the tab control in a GUI. In one aspect of the embodiment, determining a priority for each tab in a tab control can include applying a higher priority to more frequently used tabs and applying a lower priority to less frequently used tabs. In another aspect of the embodiment, determining a priority for each tab in a tab control can include applying a higher priority to more recently used tabs and applying a lower priority to less recently used tabs.

### BACKGROUND OF THE INVENTION

1. Field of the Invention

The present invention relates to the field of user interface control management and more particularly to tab control resizing in a user interface.

2. Description of the Related Art

The conventional graphical user interface (GUI) has been widely used for many years. The primary function of the GUI includes providing visual controls with which the end-user can interact with an underlying application. Though the common GUI includes many stock visual controls, a select few visual controls can be combined to accommodate most computer-human interactions required by an application. For example, the static text box control can be used to present text to the end-user while an edit box can permit the user to provide textual input to the application. A radio button control can provide for the exclusive selection of an element from among a field of elements, while a checklist box can control can provide for the non-exclusive selection of elements from among a field of elements.

User interface controls ordinarily provide a visual interface which permits some sort of user interactivity, such as a mouse click for a button or check box, and an insert caret for a text field. While a textual label ordinarily is associated with the control as a separate component, the textual label for the control and the control itself often are viewed as a singular entity. As such, the combination of the textual label and the control provide two basic informational components: the identity of the control and the immediate state of the control, e.g. selected, input provided, etc. Notably, over the years, the basic idea of the user interface control has not changed, despite increases in the expressive power of other aspects of the GUI.

Certain types of a GUI controls can produce clutter in a view due to the separate nature of the label and control. In particular, where the label for the control exceeds the width of the control itself, a limited number of controls can be placed adjacent to one another in a view while maintaining an orderly appearance. Also, the distance between each control can increase as the width of the label far exceeds that of the control. In many cases, groups of controls are arranged together such as an arrangement of radio buttons grouped together to provide a singular choice among the choices corresponding to the radio buttons. In this case, it can be important to arrange the controls close enough together to indicate that a user is to choose one radio button from amongst the arrangement of radio buttons.

Tabbed portions of a GUI address the problem of GUI clutter by providing a third-dimension to a two-dimensional portion of a GUI. The third-dimension incorporates different views to the same two-dimensional portion of the GUI in which each view can be accessed through the selection of a corresponding tab control much in the same way that a tabbed filing cabinets provides ease of access to different papers in a file without requiring each paper to remain in plain view in the filing cabinet. In this way, the two-dimensional portion of the GUI, with respect to the GUI can be minimized to provide a clutter-free environment.

Tabbed portions of a GUI can be most effective with a limited number of tabs. As more tabs are added to a tab control, the width of each tab compresses along with descriptive text provided in each tab. Once each tab has compressed substantially, it is difficult for an end-user to determine which content is associated with which tab thereby defeating the purpose of the tab control. Notably, as tabs are added to a tab control, generally, each of the tabs for the tab control shrink equidistantly. Consequently, no one tab is favored over another and the text in each tab will become obscured uniformly.

### BRIEF SUMMARY OF THE INVENTION

Embodiments of the present invention address deficiencies of the art in respect to tab width truncation in a tab control and provide a method, system and computer program product for differentiated truncation of tabs in a tab control. In one embodiment, a differentiated tab truncation method can be provided. The method can include determining a priority for each tab in a tab control, adjusting at least one dimension for each tab in the tab control according to the determined priority, and rendering the tab control in a GUI. In one aspect of the embodiment, determining a priority for each tab in a tab control can include applying a higher priority to more frequently used tabs and applying a lower priority to less frequently used tabs. In another aspect of the embodiment, determining a priority for each tab in a tab control can include applying a higher priority to more recently used tabs and applying a lower priority to less recently used tabs.

In another embodiment of the invention, a differentiated tab truncating data processing system can be provided. The system can include a GUI, a tab control disposed in the GUI, a multiplicity of tabs disposed in the tab control, and differentiated tab truncation logic. The logic can include program code enabled to determine a priority for each of the tabs in the tab control, and to adjust at least one dimension for each of the tabs in the tab control according to the determined priority. In one aspect of the embodiment, the dimension can be either height or width. In another aspect of the embodiment, the priority can be based upon the most frequently used tabs, or the most recently used tabs.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a GUI incorporating a tab control configured for differentiated tab width truncation;

FIG. 2A is a schematic illustration of a local GUI rendering data processing system configured for differentiated tab width truncation; and,

FIG. 2B is a schematic illustration of a network GUI rendering data processing system configured for differentiated tab width truncation; and,

FIG. 3 is a flow chart illustrating a process for differentiated tab width truncation.

### DETAILED DESCRIPTION OF THE INVENTION

Embodiments of the present invention provide a method, system and computer program product for differentiated tab width truncation. In accordance with an embodiment of the present invention, a tab control including multiple different tabs can be configured for rendering in a GUI. If the tab control is determined not to be dimensioned large enough to accommodate the tabs without truncating each tab beyond a threshold value, selected ones of the tabs can be truncated in size more than others in order to ensure that the text of the higher priority tabs remain functionally visible at the expense of the text other lower priority tabs which may be rendered functionally invisible.

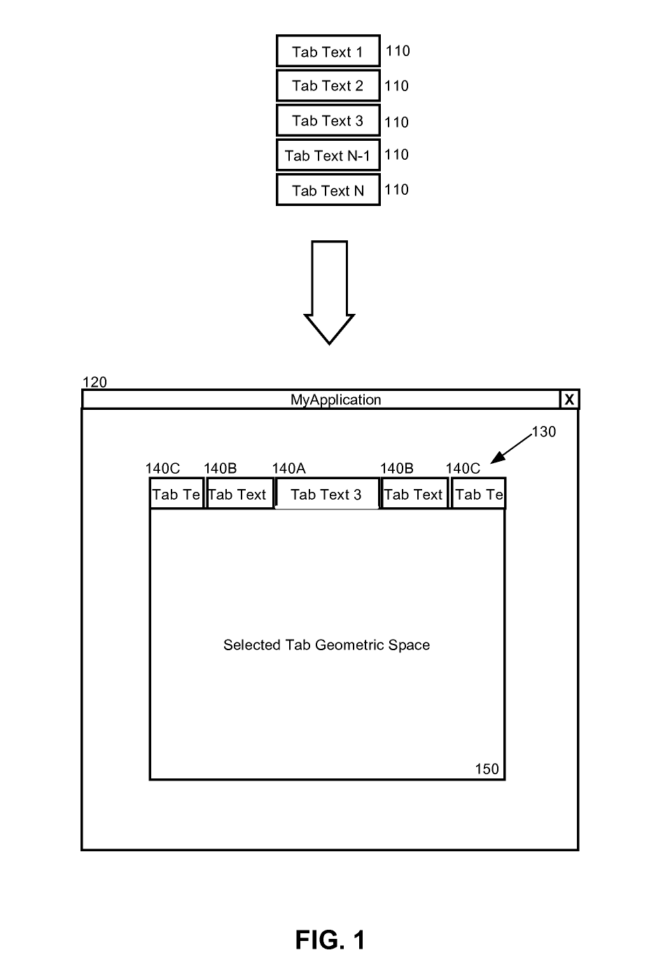

In illustration, FIG. 1 is a pictorial illustration of a GUI incorporating a tab control configured for differentiated tab width truncation. As shown in FIG. 1, a set of tabs 110 can be arranged for presentation in a tab control 130 in a GUI 120. The tab control 130 can provide a series of two-dimensional view spaces 150, each associated with a corresponding one of the tabs 110. Notably the available space for rendering the tabs 110 in the tab control 130 fall short of the sum total of the space required to render each of the tabs 110 in sequence without shrinking the tabs 110.

As such the tabs 110 can be transformed into differentiated truncated tabs 140A, 140B, 140C so as to provide maximum space for higher priority tabs 140A, 140B, while lower priority tabs 140C can be truncated to accommodate the higher priority tabs 140A, 140B. In one aspect of the invention, the current tab 140A can be considered to be of the highest priority, more recently selected tabs 140B can be viewed as of moderate priority, and the least recently used tabs 140C can be viewed as of the least priority. It will be recognized by the skilled artisan that other modes of prioritization can be considered including frequency of use.

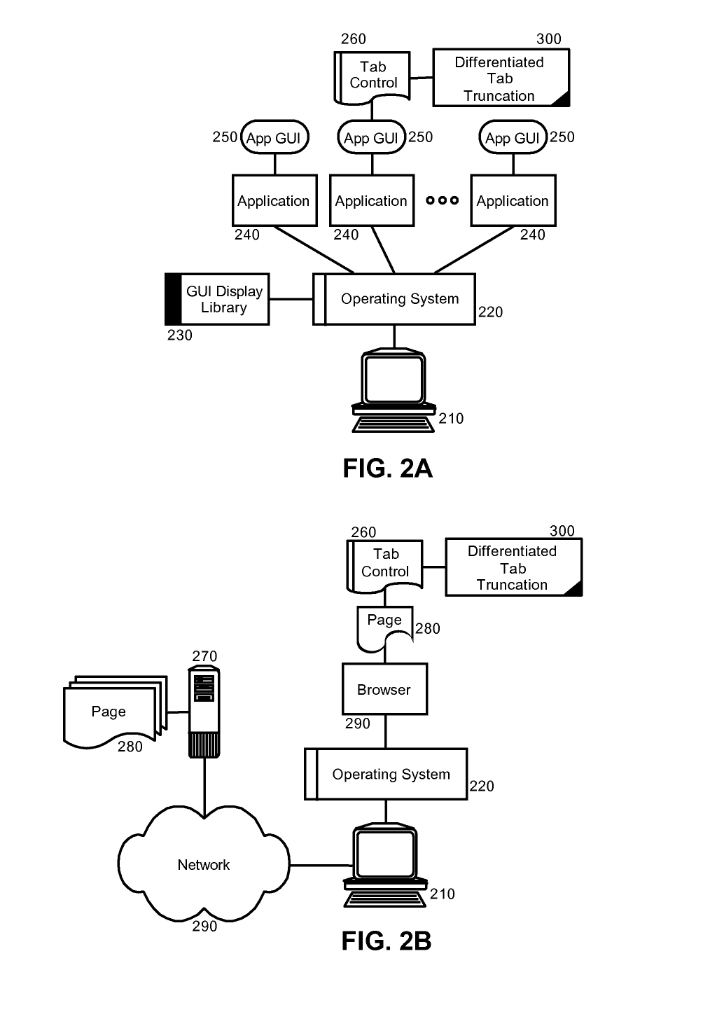

Turning now to FIG. 2A, a schematic illustration depicts a local GUI rendering data processing system configured for differentiated tab width truncation. In the local GUI configuration, a host computing platform 210 can support an operating system 220. The operating system 220 can manage the execution of one or more applications 240, each of the applications 240 providing an application GUI 250.

In accordance with an embodiment of the invention, a tab control 260 can be included in an application GUI 250 for an application 240. The tab control 260 can provide an arrangement of multiple tabs in a dimensionally defined space, each tab corresponding to a two-dimensional field of view in the tab control 260. The sizing of each tab in the tab control 260, however, can vary depending upon a priority assigned to each tab by differentiated tab truncation logic 300. In this regard, the differentiated tab truncation logic 300 can include program code enabled to prioritize different tabs in the tab control and to maximize the dimensioning of priority tabs while sacrificing dimensioning of tabs of lesser priority.

The arrangement shown in FIG. 2B relates to the standalone generation of a GUI in a host computing environment. It is to be recognized by the skilled artisan, however, that GUI controls further can be distributed within distributable markup as is well-known in the distributed computing arts. In consequence, FIG. 2B is a schematic illustration of a network GUI rendering data processing system configured for differentiated tab width truncation. In the embodiment shown in FIG. 2B, the host computing platform 210 can be communicatively coupled to a page server 270 configured to distribute pages 280 over a computer communications network 290. The operating system 220 supported by the host computing platform 210 can manage the execution of a page browser 290 configured to render pages 280 received from the page server 280 over the computer communications network 290.

As shown in FIG. 2B, a rendered page 280 in the browser 290 can include a tab control 260. The tab control 260 can be defined within the markup of the page 280, or can be defined by script logic incorporated within the page 280 or referenced by the page 280. The tab control 260 can be coupled to differentiated tab truncation logic 300. In this regard, the differentiated tab truncation logic 300 can be incorporated as part of script defining the tab control 260, or the differentiated tab truncation logic 300 can be referenced by script or markup defining the tab control 260. In either case, the differentiated tab truncation logic 300 can include program code enabled to prioritize different tabs in the tab control and to maximize the dimensioning of priority tabs while sacrificing dimensioning of tabs of lesser priority.

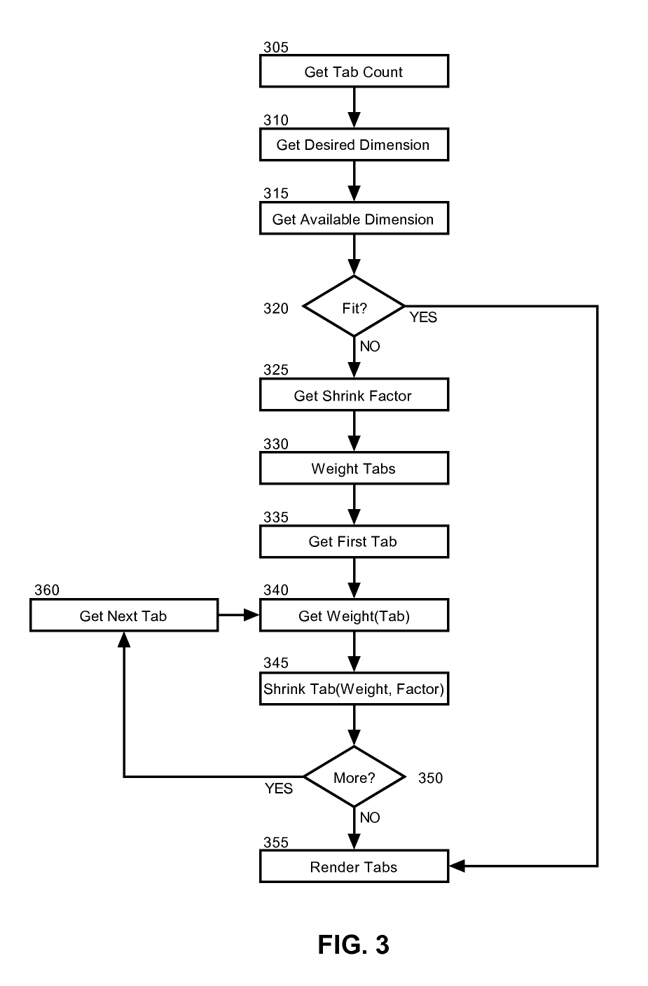

In yet further illustration, FIG. 3 is a flow chart illustrating a process for differentiated tab width truncation. Beginning in block 305, the number of tabs to be sequenced and displayed within the tab control can be determined. In block 310, a desired dimension for the tabs, for instance a desired width or height, can be determined such that the preferred available dimension in the tab control can be the product of the tab count and the preferred available dimension. Finally, the actual available dimension for the tab control can be determined so that it will be apparent whether or not the tabs at their desired dimensions will fit within the tab control without modification.

In decision block 320, if the tab control will accommodate the tabs without modification, the process can end in block 355 with a full rendering of the tabs in the tab control. Otherwise, in block 325, a shrink factor can be determined for the tabs that can be defined as the unit shrinkage required to fit the tabs in the tab control according to the actual available dimension for the tab control. In block 330, each of the tabs can be weighted according to priority. For instance the more frequently or more recently used tabs can be accorded a higher weight, whereas less frequently or less recently used tabs can be accorded a lower weight. Clearly, the currently selected tab in the tab control will be accorded the highest priority or highest weight.

In block 335, a first tab in the tab control can be selected for processing and in block 340, a weight can be determined for the tab. In block 345, the tab can be shrunk proportionally according to the shrink factor as reduced fractionally by the weight. In this regard, a fraction whose denominator is based on the weight can be applied to the shrink factor to determine proportionately how to shrink the dimension of the selected tab. Thereafter, in decision block 350, if additional tabs in the tab control remain to be processed, in block 360 the next tab in the tab control can be retrieved for processing and the shrinking process can continue in block 340. When no further tabs remain to be processed in the tab control in decision block 350, in block 355 the tabs in the tab control can be rendered and the process can end.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A differentiated tab truncation method comprising:
determining a priority for each tab in a tab control;
adjusting at least one dimension for each tab in the tab control according to the determined priority; and,
rendering the tab control in a graphical user interface (GUI).

2. The method of claim 1, wherein determining a priority for each tab in a tab control, comprises applying a higher priority to more frequently used tabs and applying a lower priority to less frequently used tabs.

3. The method of claim 1, wherein determining a priority for each tab in a tab control, comprises applying a higher priority to more recently used tabs and applying a lower priority to less recently used tabs.

4. The method of claim 3, further comprising applying a highest priority to a currently selected tab.

5. The method of claim 1, wherein adjusting at least one dimension for each tab in the tab control according to the determined priority, comprises adjusting a width of each tab in the tab control according to the determined priority.

6. The method of claim 1, wherein adjusting at least one dimension for each tab in the tab control according to the determined priority, comprises adjusting a height of each tab in the tab control according to the determined priority.

7. The method of claim 1, wherein adjusting at least one dimension for each tab in the tab control according to the determined priority, comprises:
computing a desired dimension of the tab control to accommodate a desired dimension for all of the tabs;
determining whether the desired dimension can be accommodated by an actual dimension of the tab control; and,
if the tab control cannot accommodate the desired dimension, computing a shrink factor to be applied to all tabs to reduce the overall dimension of all of the tabs to fit in the tab control, weighting each of the tabs by priority, and shrinking the dimension of each tab in the tab control by a pro-rata amount of the shrink factor adjusted by a correspondingly assigned weight.

8. The method of claim 1, wherein rendering the tab control in a GUI, comprises rendering the tab control in a markup browser.

9. A differentiated tab truncating data processing system comprising:
a graphical user interface (GUI);
a tab control disposed in the GUI;
a plurality of tabs disposed in the tab control; and,
differentiated tab truncation logic comprising program code enabled to determine a priority for each of the tabs in the tab control, and to adjust at least one dimension for each of the tabs in the tab control according to the determined priority.

10. The system of claim 10, wherein the dimension comprises a dimension selected from the group consisting of height and width.

11. The system of claim 10, wherein the GUI is defined within a network distributed page.

12. The system of claim 10, wherein the priority is selected from the group consisting of most frequently used and most recently used.

13. A computer program product comprising a computer usable medium embodying computer usable program code for differentiated tab truncation, the computer program product comprising:
computer usable program code for determining a priority for each tab in a tab control;
computer usable program code for adjusting at least one dimension for each tab in the tab control according to the determined priority; and,
computer usable program code for rendering the tab control in a graphical user interface (GUI).

14. The computer program product of claim 13, wherein the computer usable program code for determining a priority for each tab in a tab control, comprises computer usable program code for applying a higher priority to more frequently used tabs and applying a lower priority to less frequently used tabs.

15. The computer program product of claim 13, wherein the computer usable program code for determining a priority for each tab in a tab control, comprises computer usable program code for applying a higher priority to more recently used tabs and applying a lower priority to less recently used tabs.

16. The computer program product of claim 15, further comprising computer usable program code for applying a highest priority to a currently selected tab.

17. The computer program product of claim 13, wherein the computer usable program code for adjusting at least one dimension for each tab in the tab control according to the determined priority, comprises computer usable program code for adjusting a width of each tab in the tab control according to the determined priority.

18. The computer program product of claim 13, wherein the computer usable program code for adjusting at least one dimension for each tab in the tab control according to the determined priority, comprises computer usable program code for adjusting a height of each tab in the tab control according to the determined priority.

19. The computer program product of claim 13, wherein the computer usable program code for adjusting at least one dimension for each tab in the tab control according to the determined priority, comprises:
computer usable program code for computing a desired dimension of the tab control to accommodate a desired dimension for all of the tabs;
computer usable program code for determining whether the desired dimension can be accommodated by an actual dimension of the tab control; and,
computer usable program code for computing a shrink factor to be applied to all tabs to reduce the overall dimension of all of the tabs to fit in the tab control, weighting each of the tabs by priority, and shrinking the dimension of each tab in the tab control by a pro-rata amount of the shrink factor adjusted by a correspondingly assigned weight, if the tab control cannot accommodate the desired dimension.

20. The computer program product of claim 13, wherein the computer usable program code for rendering the tab control in a GUI, comprises computer usable program code for rendering the tab control in a markup browser.
